(19) United States
(12) Patent Application Publication
(10) Pub. No.: US 2026/0170726 A1
(43) Pub. Date: Jun. 18, 2026

(54) CONTENT SEARCHING

(71) Applicant: Beijing Zitiao Network Technology Co., Ltd., Beijing (CN)

(72) Inventors: Songyu WANG, Beijing (CN); Yanhan Jin, Beijing (CN)

(21) Appl. No.: 19/305,709

(22) Filed: Aug. 20, 2025

(30) Foreign Application Priority Data
Dec. 13, 2024 (WO) PCT/CN2024/139415

(51) Int. Cl. G06T 11/60; G06F 16/538

(52) U.S. Cl. CPC G06T 11/60; G06F 16/538

(57) ABSTRACT

According to embodiments of the disclosure, a method and an apparatus of content searching are provided. The method includes: receiving a search request of a user; and presenting, in response to the search request, a cover image of the media content in a search interface, wherein the cover image is determined based on at least one image associated with the media content, and the at least one image is determined based on the search request.

### CROSS-REFERENCE

This application claims priority to International Patent Application No. PCT/CN2024/139415, filed on Dec. 13, 2024, and entitled “METHOD, APPARATUS, DEVICE, AND STORAGE MEDIUM OF CONTENT SEARCHING” , which is incorporated herein by reference in its entirety.

### FIELD

Example embodiments of the present disclosure generally relate to the field of computers, and more particularly, to content searching.

### BACKGROUND

Content searching technology is a key support of the information age, and a core thereof is to efficiently and accurately extract information that users require from massive data. In the field of content searching, a cover image of the search result plays a crucial role for filtering content.

### SUMMARY

In a first aspect of the present disclosure, a method of content searching is provided. The method includes: receiving a search request of a user; and presenting, in response to the search request, a cover image of the media content in a search interface, wherein the cover image is determined based on at least one image associated with the media content, and the at least one image is determined based on the search request.

In a second aspect of the present disclosure, an apparatus for content searching is provided. The apparatus includes: a receiving module configured to receive a search request of a user; and a presenting module configured to present, in response to the search request, a cover image of the media content in the search interface, wherein the cover image is determined based on at least one image associated with the media content, and the at least one image is determined based on the search request.

In a third aspect of the present disclosure, an electronic device is provided. The devices includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

It should be understood that the content described in this Summary is not intended to limit the key features or important features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. Throughout the drawings, the same or similar reference signs denote the same or similar elements, where:

FIG. 1 illustrates a schematic diagram of an example environment in which embodiments according to the present disclosure may be implemented;

FIGS. 2A to 2D illustrate example interfaces for content searching according to some embodiments of the present disclosure;

FIG. 3 illustrates a flowchart of an example process of content searching according to some embodiments of the disclosure;

FIG. 4 illustrates a schematic structural block diagram of an example apparatus for content searching according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the heading of any section/subsection provided in this article is not limiting. Various embodiments are described throughout herein, and any type of embodiments may be included in any section/subsection. Furthermore, the embodiments described in any section/subsection may be combined in any way with any other embodiments in the same section/subsection and/or any other embodiment described in different sections/subsections.

In the description of the embodiments of the present disclosure, the terms “including” and similar expressions should be understood as an open-ended inclusion, this is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or the same objects. Other explicit and implicit definitions may also be included below.

Embodiments of the present disclosure may relate to data of a user, acquisition and/or use of data, and the like. These aspects all comply with corresponding laws, regulations and related regulations. In the embodiments of the present disclosure, collection, obtaining, processing, processing, forwarding, use, etc. of all data, are performed with the user's knowledge and confirmation. Accordingly, when implementing each embodiments of the present disclosure, users should be informed of the type, scope of use, usage scenarios, etc. that may be involved in the data or information and obtain their authorization through appropriate means in accordance with relevant laws and regulations. The specific notification and/or authorization methods may vary according to actual situations and application scenarios, and the scope of the present disclosure is not limited in this respect.

In the solutions in the present specification and the embodiments, if the processing of personal information is involved, the processing will be carried out on the premise of that is a basis of legality(for example, consent of the subject of the personal information is obtained, or it is necessary to fulfill a contract, etc.), and the processing will be carried out within the scope of the stipulations or agreements. The user refusing to process personal information other than that which is necessary for the basic functions will not affect the user's use of the basic functions.

As mentioned above, content searching technology is a key support of the information age, and the core thereof is to efficiently and accurately extract the information that users require from massive data. In the field of content searching, the cover image of the search result plays a crucial role for filtering content.

The embodiment of the present disclosure provides a solution of content searching. The solution includes: receiving a search request of a user; and in response to the search request, presenting a cover image of the media content in a search interface. The cover image is determined based on at least one image associated with the media content, and the at least one image is determined based on the search request.

In this way, the embodiments of the present disclosure can present the cover image associated with the search request in the search interface, and the theme information of the media content can be known through the cover image, thereby improving the efficiency of obtaining information.

Various example implementations of this solution are described in detail below with reference to the accompanying drawings.

### EXAMPLE ENVIRONMENT

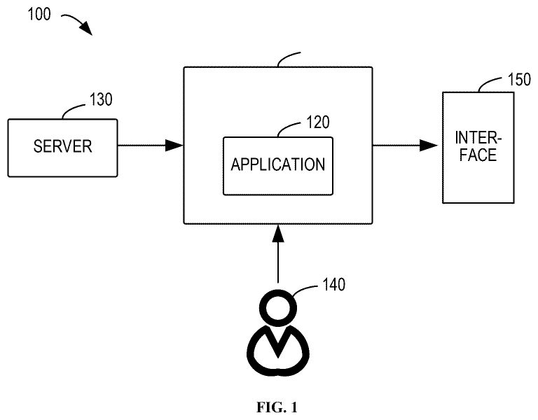

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports content searching. Application 120 may be any suitable type of application for content searching, examples of which may include, but are not limited to: social applications, content sharing applications, online video applications, or other suitable applications. The user 140 may interact with the application 120 via the electronic device 110 and/or its attachment device.

In the environment 100 of FIG. 1, in the case of the application 120 is in an active state, the electronic device 110 may present an interface 150 for supporting content searching through the application 120.

In some embodiments, the electronic device 110 communicates with the server 130 to enable provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game console, a VR (virtual reality)/AR (augmented reality) device, a Personal Communication System (PCS) device, a personal navigation device, a Personal Digital Assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, or may be a server cluster or a distributed system that consists of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms, and so on. The server 130 may include, for example, a computing system/server, such as a mainframe, an edge computing node, a computing device in a cloud environment, and the like. The server 130 may provide background services for the application 120 in the electronic device 110 that supports content searching.

A communication connection may be established between the server 130 and the electronic device 110. The Communication connection may be established via a wired or wireless manner. The Communication connection may include, but is not limited to, a Bluetooth connection, a mobile network connection, a Universal Serial Bus (USB) connection, a Wireless Fidelity (Wi-Fi) connection, and so on. The embodiments of the present disclosure are not limited in this aspect. In the embodiments of the present disclosure, the server 130 and the electronic device 110 may implement signaling interaction through a communication connection in between.

It should be understood that the structures and functions of various elements in the environment 100 are described for illustrative purposes only and do not imply any limitation to the scope of the present disclosure.

Some example embodiments of the present disclosure will continue to be described below with continued reference to the accompanying drawings.

### EXAMPLE INTERACTION

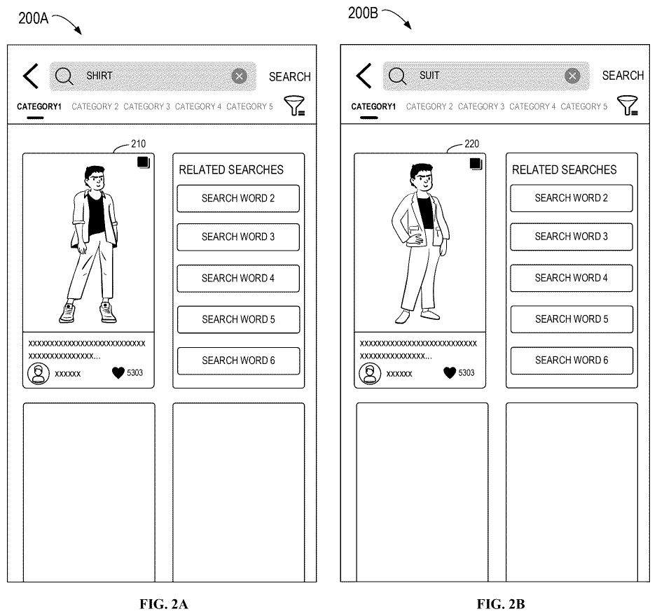

FIGS. 2A to 2D illustrate example interfaces 200A to 200D according to some embodiments of the present disclosure. The interface 200A to the interface 200D may be provided, for example, by the electronic device 110 shown in FIG. 1.

In some embodiments, the electronic device 110 receives a search request of a user. As an example, the electronic device 110 may obtain, via a search component in any appropriate interface, a search request input by the user 140 through the search component, wherein the search request may be, for example, a search term input by the user 140. Such a search term may be, for example, text content (e.g., “hairstyle”, “outfit”, “how to make tomato scrambled eggs”, “shirt”, “suit”, etc.) or image content (e.g., hairstyle images, shirts images, etc.). The interface where the search component is located may be, for example, an interface for presenting an information flow.

In some embodiments, after the electronic device 110 receives the search request, the electronic device 110 may present the cover image of the search result in the search interface. Specifically, the electronic device 110 presents the cover image of the media content in the search interface in response to the search request. The cover image is determined based on at least one image associated with the media content. The at least one image is determined based on the search request. The media content includes video content, and the at least one image includes at least one video frame in the video content. Such an image may be, for example, at least a part image cropped by the server 130 from one video frame associated with the media content. For example, the server 130 may crop the image part associated with the predetermined object from a target video frame.

As an example, after the electronic device 110 receives the search term (i.e., the search request), the electronic device 110 may present the interface 200A as shown in FIG. 2A, and the interface 200A may be a search result interface associated with the search term. The interface 200A includes a cover image 210, and the cover image is determined from the media content based on the search request.

For example, the search term may be an accurate search word, and the precise search word may be, for example, an explicit object name, for example, “shirt”. After electronic device 110 receives the word “shirt”, the image associated with the shirt in the media content may be presented in interface 200A as cover image 210.

As an example, the electronic device 110 may receive a selection of the cover image 210, and may accordingly present a viewing interface of the media content, and may play a corresponding media content.

Similarly, as shown in FIG. 2B, after receiving the word “suit”, the electronic device 110 may present the cover image 220 in the interface 200B. The cover image 220 is an image associated with the word “suit” in the media content. For example, for the same media content, different search requests may trigger presentation of different cover images corresponding to the same media content.

In some scenarios, as shown in FIG. 2C, the search term may also be a category of an object, such as “clothing”. After receiving the word “clothing”, the electronic device 110 may obtain the media content associated with the “clothing” category. Further, the electronic device 110 may obtain a plurality of images (for example, images of shirts and suits) associated with the “clothing” category from the media content, and determine a cover image 230 of the media content based on the plurality of images to present the cover image 230 to the user 140.

Additionally, or alternatively, the cover image in the interface 200A may be manually set by a poster of the media content, or may be at least one image obtained by the server 130 from the media content based on the search request.

In some embodiments, the cover image of the media content may be generated by the server 130 based on the obtained search request. Specifically, the at least one image includes a plurality of images determined from an image set associated with the media content based on the search request, and the cover image is generated by stitching the plurality of images.

As an example, as shown in FIG. 2C, the server 130 may obtain a search request input by a user, and obtain a plurality of images associated with the search request from the media content based on the obtained search request. For example, if the search term (i.e., the search request) is “clothing,” the server 130 may then obtain a plurality of images (e.g., images of shirts and suits) associated with “clothing” from the media content.

That is, for the same media content, in a case where the search terms are different, the number of images on which the cover image is based may also be different. Taking FIGS. 2A and 2B as examples, in the case where the search request expressed by the search term is clear, its cover image may be generated based on a single video frame in the media content. In contrast, taking FIG. 2C as an example, in a case where the search request expressed by the search term matches a plurality of video frames, the cover image may also be generated by stitching the plurality of matched video frames.

After the plurality of images in the media content are obtained, the server 130 may determine the number of images of the plurality of images and determine the target cover template based on the number of images. For example, after the server 130 determines that the number of images of the plurality of images is 2, the server 130 may obtain the cover template of the two-square grid. Furthermore, the server 130 may adjust the picture ratio of the image of the shirt and the image of the suit, to ensure that the image ratio of the two images meets the requirement of the two-square grid template. Finally, server 130 may fill the two images with the adjusted image ratio into the two-square grid template content to generate the cover image 230. After generating the cover image, the server 130 may send the cover image 230 to the electronic device 110, such that the electronic device 110 may present the cover image 230 to the user.

In some embodiments, the cover image may also be determined by the server 130 from a set of candidate cover images associated with the media content based on the search request. Such a set of candidate cover images may be pre-generated by the server 130 based on the theme information of the media content. For example, the media content is a video for introducing clothing, and the server 130 may cut out a plurality of video frames in the media content based on a type of clothing appearing in the media content, and use the cut out plurality of video frames as candidate cover images.

In some scenarios, such a set of candidate cover images may also be determined by the server 130 based on clarity and image content of video frames in the media content. The clarity may be, for example, indicate attribute parameters of video frames such as resolution, brightness, and image ratio of video frames in the media content. The server 130 may cut out, from the media content, a plurality of video frames whose clarity is greater than a first predetermined value, and select, from the plurality of video frames, at least one video frame whose image content satisfies a predetermined condition as the candidate cover image.

In some embodiments, the electronic device 110 may also present a text element associated with the cover image to the user. The text element is included in the cover image, and the text element may be generated by the server 130 based on the media content and/or the plurality of images.

As an example, as shown in FIG. 2D, the server 130 may determine theme information corresponding to the media content or the plurality of images, and the theme information may be, for example, “clothing”. When the server 130 determines that the theme information is “clothing”, the server 130 may generate the text element 240 based on “clothing”, and superimpose the text element on the cover image. Such text element may be, for example, “Which outfit looks best?”. In this way, the embodiments of the present disclosure can enrich the content included in the cover image, thereby improving efficiency of obtaining information.

In some embodiments, the text element may also be determined based on the search request. As an example, the search request may be, for example, “hairstyle suitable for boy”. After receiving the “hairstyle suitable for boy”, the server 130 may generate an associated text element, and superimpose the text element on the cover image. The text element may be, for example, “ten hairstyles most suitable for boy in this summer.”

In this way, the embodiments of the present disclosure can present more information in the search interface, thereby improving efficiency of obtaining information.

### EXAMPLE PROCESS OF GENERATING A COVER IMAGE

An example process of generating a cover image may be implemented in the server 130. An example process of generating a cover image is described below with reference to FIG. 1.

In some embodiments, the server 130 may generate a set of candidate cover images for the media content in response to at least one condition being satisfied. At least one condition includes: no cover image is set for the media content, or a set cover image for the media content fails to satisfy a first constraint. The first constraint is related to at least one of the following: at least one display parameter of the set cover image, at least one display parameter of the corresponding candidate image, image content of the set cover image, or image content of the corresponding candidate image, a correlation between the set cover image and the media content, or a correlation between the corresponding candidate image and the media content. The display parameter herein may include, for example, a parameter such as a resolution, a brightness, or an image ratio of the image. In this way, embodiments of the present disclosure can effectively improve recall accuracy of a plurality of images in media content.

As an example, when generating a set of cover images, the server 130 may first determine whether the media content has been associated with a cover image set by the user. After the media content has been associated with the predetermined cover image, the server 130 may determine whether the set cover image satisfies the plurality of conditions described above. Taking a correlation between the set cover image and the media content as an example, the server 130 may determine the correlation between the set cover image and the media content based on the set cover image and the theme information of the media content. When it is determined that the correlation is less than a second predetermined value, the server 130 may generate a plurality of cover images associated with the media content.

For example, the set cover image is an image associated with a hairstyle, and the media content is a video that describes the clothing. The server 130 may determine that a new cover image is required to be generated to replace the cover image that has been set by the user.

In some embodiments, the server 130 needs to reference the second constraint when generating a set of candidate cover images. The second constraint may be the same constraint as the first constraint. Specifically, the server 130 may determine a set of candidate images satisfying the second constraint from the image set associated with the media content. Further, the server 130 may generate a set of candidate cover images based on the set of candidate images.

As an example, when generating the set of candidate cover images, the server 130 may first determine description information of the media content. The description information may be derived from content such as a title, a text and the like uploaded by a blogger, or may be a description generated by a model through analyzing the media content. Such description information may, for example, indicate the content category (i.e., theme) of the media content. The server 130 may determine theme information corresponding to a plurality of video frames in the media content. Furthermore, the server 130 may determine a degree of association (i.e., correlation) between the theme information corresponding to the plurality of video frames and the content category. Finally, the server 130 may generate the set of candidate cover images based on a plurality of video frames with degrees of association greater than a third predetermined value.

For example, the content category may be, for example, content related to outfits, content related to hairstyle, or content related to any product. Taking the theme of the media content being the outfit content as an example, after the theme of the media content is determined to be the outfit content, the server 130 may obtain a plurality of images associated with the outfit content from the media content. The image associated with the outfit may be, for example, an image of a model worn shirt or an image of a model worn down jacket, or the like. Further, the server 130 may generate the set of candidate cover images related to the media content based on the plurality of images associated with the outfit.

Similarly, the media content may be, for example, video content for making meals. When generating a set of candidate cover images, the server 130 may segment the media content. For example, the video content for making meals includes a plurality of preparation stages, and the server 130 may separately extract one frame of image from the plurality of preparation stages to obtain a plurality of video frames for generating the cover image.

In some scenarios, the media content includes a plurality of themes, such as a clothing theme and a hairstyle theme. The server 130 may determine whether a theme of the set cover image includes the clothing theme and the hair style theme. If neither the clothing theme nor the hairstyle theme is included, the server 130 may determine that the correlation between the set cover image and the media content is insufficient.

Additionally, or alternatively, the server 130 may select, from the media content, a set of candidate images whose display parameters satisfy a first predetermined value. Furthermore, the server 130 generates a set of candidate cover images based on the selected set of candidate images.

In some embodiments, after the set of candidate cover images is generated, the server 130 may send the candidate cover image associated with the search request to the electronic device 110, causing the electronic device 110 to present the candidate cover image.

In some scenarios, the server 130 may further perform image stitching on the plurality of candidate cover images associated with the search request to generate a stitched image. Further, the server 130 may use the stitched image as a cover image of the media content, and send the stitched image to the electronic device 110.

In this way, the embodiments of the present disclosure can select at least one candidate cover image associated with the search request from the plurality of candidate cover images in the media content as the cover image, thereby improving the accuracy of obtaining information.

### EXAMPLE PROCESSES

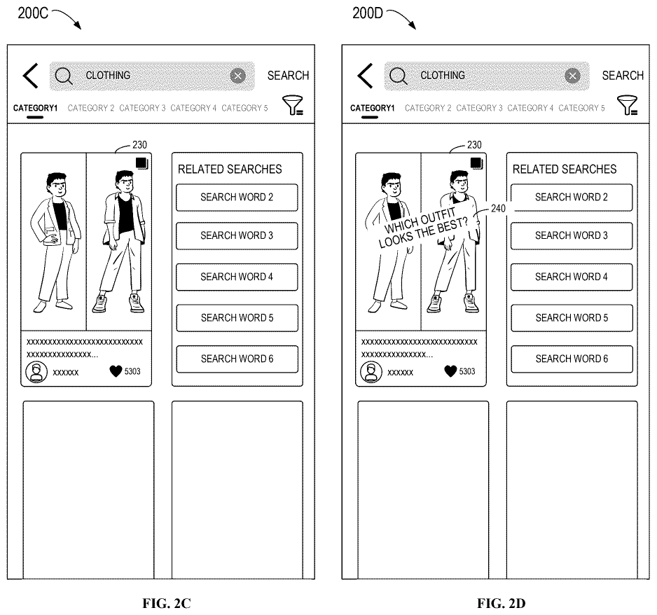

FIG. 3 illustrates a flowchart of an example process 300 of content searching according to some embodiments of the present disclosure. Process 300 may be implemented at electronic device 110. The process 300 is described below with reference to FIG. 1.

As shown in FIG. 3, at block 310, the electronic device 110 receives a search request of a user.

At block 320, the electronic device 110 presents, in response to the search request, a cover image of media content in a search interface, wherein the cover image is determined based on at least one image associated with the media content, and the at least one image is determined based on the search request.

In some embodiments, the at least one image includes a plurality of images determined from an image set associated with the media content based on the search request, and the cover image is generated by stitching the plurality of images.

In some embodiments, the at least one image is determined from a set of candidate cover images associated with the media content based on the search request.

In some embodiments, the set of candidate cover images is generated through: generating the set of candidate cover images for the media content in response to at least one condition being satisfied, wherein the at least one condition includes at least one of the following: no cover image is set for the media content; or a set cover image for the media content fails to satisfy a first constraint.

In some embodiments, generating the set of candidate cover images for the media content includes: determining a set of candidate images satisfying a second constraint from an image set associated with the media content; and generating the set of candidate cover images based on the set of candidate images.

In some embodiments, the first constraint or the second constraint is related to at least one of the following: at least one display parameter of the set cover image or at least one display parameter of a corresponding candidate image; image content of the set cover image or image content of a corresponding candidate image; or a correlation between the set cover image and the media content, or a correlation between a corresponding candidate image and the media content.

In some embodiments, the cover image further includes a text element generated based on at least one of the media content or the at least one image.

In some embodiments, text content corresponding to the text element is further determined based on the search request.

In some embodiments, the media content includes video content, and the at least one image includes at least one video frame of the video content.

### EXAMPLE APPARATUS AND DEVICES

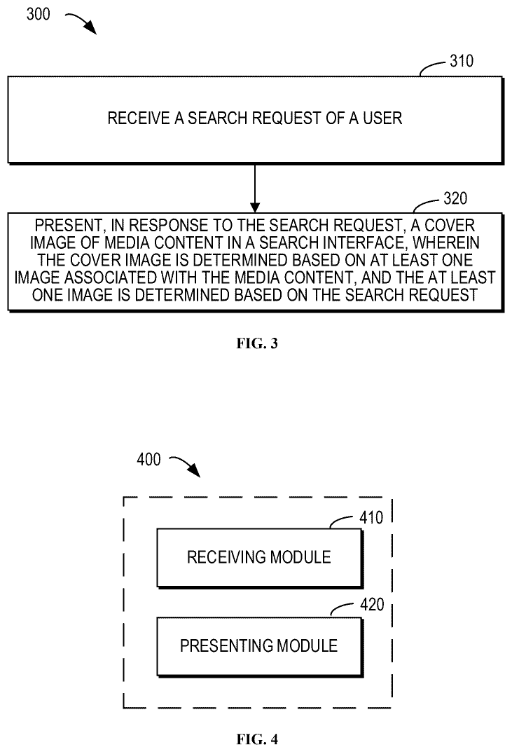

Embodiments of the present disclosure also provide a corresponding apparatus for implementing the above method or process. FIG. 4 illustrates a schematic structural block diagram of an example apparatus 400 for content searching according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: a receiving module 410 configured to receive a search request of a user; and a presenting module 420 configured to present, in response to the search request, a cover image of the media content in the search interface, wherein the cover image is determined based on at least one image associated with the media content, and the at least one image is determined based on the search request.

In some embodiments, the at least one image includes a plurality of images determined from an image set associated with the media content based on the search request, and the cover image is generated by stitching the plurality of images.

In some embodiments, the at least one image is determined from a set of candidate cover images associated with the media content based on the search request.

In some embodiments, the set of candidate cover images is generated through: generating the set of candidate cover images for the media content in response to the at least one condition being satisfied, wherein the at least one condition includes at least one of the following: no cover image is set for the media content; or a set cover image for the media content fails to satisfy a first constraint.

In some embodiments, generating the set of candidate cover images for the media content includes: determining a set of candidate images satisfying the second constraint from an image set associated with the media content; and generating the set of candidate cover images based on the set of candidate images.

In some embodiments, the first constraint or the second constraint is related to at least one of the following: at least one display parameter of the set cover image, or at least one display parameter of a corresponding candidate image; image content of the set cover image, or image content of a corresponding candidate image; or a correlation between the set cover image and the media content, or a correlation between a corresponding candidate image and the media content.

In some embodiments, the cover image further includes a text element generated based on at least one of the media content or the at least one image.

In some embodiments, text content corresponding to the text element is further determined based on the search request.

In some embodiments, the media content includes video content, and the at least one image includes at least one video frame of the video content.

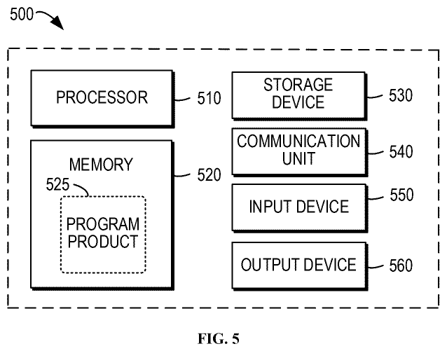

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 530 may be a removable or non-removable medium and may include a machine-readable medium, such as a flash drive, magnetic disk, or any other medium, which may be used to store information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device over a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in one or more blocks of the flowchart and/or block diagram(s).

The computer-readable program instructions may be loaded onto a computer, other programmable data processing apparatus, or other apparatus, causing a series of operational steps to be performed on a computer, other programmable data processing apparatus, or other apparatus to produce a computer-implemented process such that the instructions, when executed on a computer, other programmable data processing apparatus, or other devices implement the functions/acts specified in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions marked in the blocks may also occur in a different order than marked in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented using a combination of dedicated hardware and computer instructions.

Various implementations of the present disclosure have been described above, and the foregoing description is illustrative, not exhaustive, and is not limited to the implementations as disclosed. Many modifications and variations will be apparent to those of ordinary skill in the art without departing from the scope and spirit of the illustrated implementations. The terminology used herein has been chosen to best explain the principles of the implementations, practical applications, or improvements to techniques in the marketplace, or to enable those skilled in the art to understand the various implementations disclosed herein.

1. A method of content searching, comprising:
receiving a search request of a user; and
presenting, in response to the search request, a cover image of media content in a search interface, wherein the cover image is determined based on at least one image associated with the media content, and the at least one image is determined based on the search request.

2. The method of claim 1, wherein the at least one image comprises a plurality of images determined from an image set associated with the media content based on the search request, and the cover image is generated by stitching the plurality of images.

3. The method of claim 1, wherein the at least one image is determined from a set of candidate cover images associated with the media content based on the search request.

4. The method of claim 3, wherein the set of candidate cover images is generated through:
generating the set of candidate cover images for the media content in response to at least one condition being satisfied, wherein the at least one condition comprises at least one of the following:
no cover image is set for the media content; or
a set cover image for the media content fails to satisfy a first constraint.

5. The method of claim 4, wherein generating the set of candidate cover images for the media content comprises:
determining a set of candidate images satisfying a second constraint from an image set associated with the media content; and
generating the set of candidate cover images based on the set of candidate images.

6. The method of claim 5, wherein the first constraint or the second constraint is related to at least one of the following:
at least one display parameter of the set cover image or at least one display parameter of a corresponding candidate image;
image content of the set cover image or image content of a corresponding candidate image; or
a correlation between the set cover image and the media content, or a correlation between a corresponding candidate image and the media content.

7. The method of claim 1, wherein the cover image further comprises a text element generated based on at least one of the media content or the at least one image.

8. The method of claim 7, wherein text content corresponding to the text element is further determined based on the search request.

9. The method of claim 1, wherein the media content comprises video content and the at least one image comprises at least one video frame of the video content.

10. An electronic device, comprising:
at least one processor; and
at least one memory coupled to the at least one processor and storing instructions for execution by the at least one processor, the instructions, when executed by the at least one processor, causing the electronic device to perform acts comprising:
receiving a search request of a user; and
presenting, in response to the search request, a cover image of media content in a search interface, wherein the cover image is determined based on at least one image associated with the media content, and the at least one image is determined based on the search request.

11. The electronic device of claim 10, wherein the at least one image comprises a plurality of images determined from an image set associated with the media content based on the search request, and the cover image is generated by stitching the plurality of images.

12. The electronic device of claim 10, wherein the at least one image is determined from a set of candidate cover images associated with the media content based on the search request.

13. The electronic device of claim 12, wherein the set of candidate cover images is generated through:
generating the set of candidate cover images for the media content in response to at least one condition being satisfied, wherein the at least one condition comprises at least one of the following:
no cover image is set for the media content; or
a set cover image for the media content fails to satisfy a first constraint.

14. The electronic device of claim 13, wherein generating the set of candidate cover images for the media content comprises:
determining a set of candidate images satisfying a second constraint from an image set associated with the media content; and
generating the set of candidate cover images based on the set of candidate images.

15. The electronic device of claim 14, wherein the first constraint or the second constraint is related to at least one of the following:
at least one display parameter of the set cover image or at least one display parameter of a corresponding candidate image;
image content of the set cover image or image content of a corresponding candidate image; or
a correlation between the set cover image and the media content, or a correlation between a corresponding candidate image and the media content.

16. The electronic device of claim 10, wherein the cover image further comprises a text element generated based on at least one of the media content or the at least one image.

17. The electronic device of claim 16, wherein text content corresponding to the text element is further determined based on the search request.

18. The electronic device of claim 10, wherein the media content comprises video content and the at least one image comprises at least one video frame of the video content.

19. A non-transitory computer-readable storage medium having a computer program stored thereon, wherein the computer program is executable by a processor to implement acts comprising:
receiving a search request of a user; and
presenting, in response to the search request, a cover image of media content in a search interface, wherein the cover image is determined based on at least one image associated with the media content, and the at least one image is determined based on the search request.

20. The non-transitory computer-readable storage medium of claim 19, wherein the at least one image comprises a plurality of images determined from an image set associated with the media content based on the search request, and the cover image is generated by stitching the plurality of images.
